(19) United States
(12) Patent Application Publication
(10) Pub. No.: US 2026/0085751 A1
(43) Pub. Date: Mar. 26, 2026

(54) GEARED MOTOR, INCLUDING A GEARBOX AND AN ELECTRIC MOTOR, AND METHOD FOR PRODUCING VARIANTS IN A TYPE SERIES OF GEARED MOTORS

(71) Applicant: SEW-EURODRIVE GMBH & CO. KG, Bruchsal (DE)

(72) Inventors: Thorsten MORITZ, Ubstadt-Weiher (DE); Michael Josef HERBERGER, St. Leon-Rot (DE)

(73) Assignee: SEW-EURODRIVE GMBH & CO. KG, Bruchsal (DE)

(21) Appl. No.: 19/111,554

(22) PCT Filed: Jul. 27, 2023
(86) PCT No.: PCT/EP2023/070903

§ 371 Date: Mar. 13, 2025

(30) Foreign Application Priority Data
Sep. 13, 2022 (DE) 10 2022 003 371.2

(51) Int. Cl. F16H 57/039; F16H 1/20; F16H 57/02; F16H 57/021; F16H 57/033

(52) U.S. Cl. CPC F16H 57/039; F16H 1/203; F16H 57/021; F16H 57/033; F16H 2057/02034

(57) ABSTRACT

In a geared motor, including a gearbox and an electric motor, and a method for producing variants in a type series of geared motors, the geared motor includes a housing part of the gearbox, a bearing flange, a stator housing of the electric motor, a rotor shaft, and a bearing. The bearing is received in the bearing flange, and the inner ring of the bearing is mounted onto the rotor shaft. The bearing has a motor-side pattern of holes, and the bearing flange has a gearbox-side pattern of holes. The motor-side pattern of holes has a discreet or integer axis of rotational symmetry which is parallel to and spaced apart from a discreet or integer axis of rotational symmetry of the gearbox-side pattern of holes.

### FIELD OF THE INVENTION

The present invention relates to a geared motor, including a gearbox and an electric motor, and a method for producing variants in a type series of geared motors.

### BACKGROUND INFORMATION

In certain conventional systems, in a geared motor, an electric motor of the geared motor drives a gearbox of the geared motor.

A geared motor with an adapter flange is described in German Patent Document No. 10 2021 003 134.

A geared motor is described in German Patent Document No. 10 2014 008 330.

### SUMMARY

Example embodiments of the present invention provide a geared motor, in which a high transmission can be produced in a simple and cost-effective manner.

According to example embodiments, a geared motor includes a gearbox and an electric motor. The geared motor includes a housing part of the gearbox, a bearing flange, a stator housing of the electric motor, a rotor shaft, and a bearing. The bearing is received in the bearing flange, and the inner ring of the bearing is mounted onto the rotor shaft. The bearing flange has a motor-side pattern of holes, e.g., a motor-side pattern of holes on its side facing away from the housing part of the gearbox, e.g., for first fastening elements, e.g., screws, connecting the stator housing to the bearing flange. The bearing flange has a gearbox-side pattern of holes, e.g., a gearbox-side pattern of holes facing away from the stator housing, e.g., for further fastening elements, e.g., further screws, connecting the housing part of the gearbox to the bearing flange. The motor-side pattern of holes has a discreet or integer axis of rotational symmetry which is parallel to and spaced apart from a discreet or integer axis of rotational symmetry of the gearbox-side pattern of holes.

For example, a discrete axis of rotational symmetry, e.g., an axis of rotation symmetry, should be understood to be the mathematical axis of symmetry in which a rotation of the pattern of holes by an angle of 360°/n transfers the pattern of holes into itself, i.e., leaves it unchanged, in which n is a natural number greater than one. Alternatively, an axis of rotational symmetry with this symmetry is referred to as an integer axis of rotational symmetry, as the rotation symmetry is n-numbered.

An advantage of this is that the offset of the two parallel axes of rotational symmetry of the electric motor together with the rotor shaft relative to the axis of rotation of the gear of the input stage of the gearbox means that a greater axis offset can be achieved between the axis of rotation of the rotor shaft and the axis of rotation of the gear, and thus a much higher transmission ratio of the input angular gear stage of the gearbox. The motor is, for example, higher, i.e., shifted more in the direction perpendicular to the direction of the axis of rotation of the gear and perpendicular to the direction of the axis of rotation of the rotor shaft, i.e., with coaxial alignment of the axis of rotational symmetry of the two patterns of holes.

According to example embodiments, a geared motor includes a gearbox and an electric motor. The geared motor includes a housing part of the gearbox, a bearing flange, a stator housing of the electric motor, a rotor shaft, and a bearing. The bearing is received in the bearing flange, and the inner ring of the bearing is mounted onto the rotor shaft. The bearing flange has a first cheek and a second cheek connected to the first cheek via a web. For example, the second cheek is arranged on the side of the web axially facing away from the stator housing, and the first cheek is arranged on the side axially facing away from the housing part of the gearbox, in which the axial direction is oriented parallel to the axis of rotation of the rotor shaft. The first cheek is centered relative to the stator housing via a first centering collar, and the first centering collar is formed on the first cheek or on the stator housing. The second cheek is centered to the housing part of the gearbox via a second centering collar, and the second centering collar is formed on the second cheek or on the housing part of the gearbox. The first centering collar has an axis of rotational symmetry which is oriented parallel to and spaced apart from an axis of rotational symmetry of the second centering collar, and/or the first centering collar is arranged as an uninterrupted or interrupted circular ring, the ring axis of which is oriented parallel to and spaced apart from the ring axis of the second centering collar arranged as an uninterrupted or interrupted circular ring. For example, the first centering collar is arranged as a hollow cylinder, and the second centering collar is arranged as a further hollow cylinder.

As described herein, a circular ring should be understood to be an annular spatial region that resembles a flat hollow cylinder.

An advantage of this is that fitting and/or centering can be carried out quickly and readily when connecting the bearing flange to the stator housing or the housing part.

Another advantage is that the offset of the two parallel axes of rotational symmetry or ring axes of the electric motor together with the rotor shaft relative to the axis of rotation of the gear of the input stage of the gearbox means that a greater axis offset can be achieved between the axis of rotation of the rotor shaft and the axis of rotation of the gear and thus a much higher transmission ratio of the input angular gear stage of the gearbox. The motor is, for example, higher, i.e., shifted more in the direction perpendicular to the direction of the axis of rotation of the gear and perpendicular to the direction of the axis of rotation of the rotor shaft, i.e., with coaxial orientation of the axis of rotational symmetry or ring axis.

The arrangement described herein provides for a smaller axial distance between the axis of rotation of the gear and the axis of rotation of the pinion to be obtained, and thus also smaller transmission numbers, in the case of a replacement of the bearing flange with another bearing flange during which the two patterns of holes are oriented coaxially to one another. By stocking the two different bearing flanges, different variants of geared motors can be produced as required. Overall, a high degree of variance can thus be achieved with few components, e.g., when producing variants in a type series of geared motors.

According to example embodiments, the axis of rotation of the rotor shaft is oriented coaxially to the discrete or integer axis of rotational symmetry of the motor-side pattern of holes. An advantage of this is that the bearing flange can be readily oriented to the rotor shaft.

According to example embodiments, the axis of rotation of the rotor shaft is oriented coaxially to the axis of rotational symmetry of the first centering collar and/or to the ring axis of the first centering collar.

An advantage of this is that the bearing flange can be readily oriented to the rotor shaft.

According to example embodiments, the axis of rotation of the rotor shaft is coaxial to the axis of rotation of the bearing. An advantage of this is that the rotor shaft can be mounted rotatably via the bearing.

According to example embodiments, a shaft seal ring is received in the bearing flange, which ring seals towards the rotor shaft. For example, the shaft seal ring is arranged on the side axially facing away from the stator housing. An advantage of this is that increased tightness can be achieved.

According to example embodiments, a pinion is connected to the rotor shaft for conjoint rotation, which pinion is in mesh with a crown-toothed gear. For example, the axis of rotation of the gear is oriented perpendicular to the axis of rotation of the rotor shaft. The pinion has worm gearing, e.g., ZA worm gearing. An advantage of this is that the pinion is readily and inexpensively produced.

According to example embodiments, the gear has teeth extending in an arc from radially inwards to radially outwards in the circumferential direction. For example, the gear is a Spiroplan® gear. An advantage of this is that a higher transmission can be achieved.

According to example embodiments, the gear is connected to a further gear wheel for conjoint rotation, which is in mesh with a third gear wheel, which is connected to the output shaft of the transmission, or is connected to a fourth gear wheel for conjoint rotation, which is connected to the output shaft of the gearbox. An advantage of this is that even higher transmission numbers can be achieved with further gearbox stages.

According to example embodiments, the housing part is manufactured as a cast part, and a channel passing through the wall of the housing part is manufactured via a slider, the drawing direction of which has a non-vanishing angle, e.g., an angle between 10° and 40°, to the axis of rotation of the rotor shaft. An advantage of this is that the housing part has increased stability and rigidity on the input side. In addition, the rotor shaft with the pinion projects through the channel into the interior of the gearbox so that the gear, which is arranged in the interior of the gearbox, is in mesh with the pinion.

According to example embodiments, the rotor shaft with the pinion projects into the channel or through the channel. An advantage of this is that the pinion is predominantly arranged in the channel, and the installation space is thus used efficiently.

According to example embodiments, the axis of rotation of the gear is oriented perpendicular to the axis of rotation of the rotor shaft. An advantage of this is that the input gear stage is an angular gear stage.

According to example embodiments, the axis of rotation of the gear has a non-vanishing axial distance to the axis of rotation of the rotor shaft. An advantage of this is that a high transmission can be achieved.

According to example embodiments, the first centering collar is oriented parallel to the second centering collar, e.g., with the axis of rotational symmetry of the first centering collar being oriented parallel to the axis of rotational symmetry of the second centering collar. An advantage of this is that the ring axes of the two annular centering collars are oriented parallel to one another, but are spaced apart from one another. This makes it possible to achieve and manufacture a high transmission in a ready and cost-effective manner.

According to example embodiments, the first and second cheek of the bearing flange are connected via ribs formed on the web of the bearing flange. For example, the ribs are spaced apart from one another in the circumferential direction, e.g., in relation to the axis of rotation of the rotor shaft, e.g., evenly spaced apart. For example, the outermost radial distance of the respective rib, e.g., measured at a respective axial position, e.g., in relation to the axis of rotation of the rotor shaft, decreases monotonically, e.g., strictly monotonically, with increasing axial distance from the stator housing. For example, at least two ribs have a different extension in the radial direction, and/or the extension of the ribs in the radial direction is a non-constant function of the circumferential angle. For example, at a respective circumferential angle, the radial distance region covered by the respective rib in the radial direction is adjacent to the radial distance region covered by the web. An advantage of this is that the bearing flange has increased rigidity and improved heat dissipation, e.g., of the heat loss from the bearing. However, as a result of the different lengths, resonance vibrations are also suppressed. This is because the ribs of different lengths are arranged distributed around the circumference and thus unevenly distributed ribs are formed around the circumference so that corresponding natural vibrations or resonance vibrations are suppressed.

In addition, the stability is increased in that the respective ribs have a maximum radial distance from the motor to the gearbox, e.g., from the first cheek to the second cheek, which decreases with increasing axial distance from the stator housing, e.g., the radial distance is related to the axis of rotation of the rotor shaft.

According to example embodiments, in a method for producing variants of a type series of geared motors, a first or a second bearing flange is selected from a modular system and connected to a housing part of the modular system and a stator housing of the modular system. If the first bearing flange is selected as the first variant, an aforementioned geared motor is produced, and, if the second bearing flange is selected as the second variant, a geared motor is produced which has a lower transmission ratio than the aforementioned geared motor.

An advantage of this is that a high variance of the type series can be achieved with a small number of parts.

According to example embodiments, the second bearing flange has a motor-side pattern of holes, e.g., on its side facing away from the housing part of the gearbox, e.g., for first fastening elements, e.g., screws, connecting the stator housing to the bearing flange. The second bearing flange has a gearbox-side pattern of holes, e.g., a gearbox-side pattern of holes facing away from the stator housing, e.g., for further fastening elements, e.g., further screws, connecting the housing part of the gearbox to the second bearing flange. The motor-side pattern of holes of the second bearing flange has a discreet or integer axis of rotational symmetry which is coaxial to a discreet or integer axis of rotational symmetry of the gearbox-side pattern of holes.

An advantage of this is that the second bearing flange can be used instead of the first bearing flange, allowing a lower transmission ratio to be achieved.

According to example embodiments, the second bearing flange has a first cheek and a second cheek connected to the first cheek via a web. For example, the second cheek is arranged on the side of the web axially facing away from the stator housing, and the first cheek is arranged on the side axially facing away from the housing part of the gearbox, in which the axial direction is oriented parallel to the axis of rotation of the rotor shaft. The first cheek is centered relative to the stator housing via a first centering collar, and the first centering collar is formed on the first cheek or on the stator housing. The second cheek is centered to the housing part of the gearbox via a second centering collar, and the second centering collar is formed on the second cheek or on the housing part of the gearbox. The first centering collar has an axis of rotational symmetry which is oriented coaxially to an axis of rotational symmetry of the second centering collar, and/or the first centering collar is arranged as an uninterrupted or interrupted circular ring, the ring axis of which is oriented coaxially to the ring axis of the second centering collar arranged as an uninterrupted or interrupted circular ring. For example, the first centering collar is arranged as a hollow cylinder, and the second centering collar is arranged as a further hollow cylinder.

An advantage of this is that a variant with a higher or lower transmission number can be achieved.

An advantage of this is that the second bearing flange can be used instead of the first bearing flange, allowing a lower transmission ratio to be achieved.

Further features and aspects of example embodiments of the present invention are explained in more detail below with reference to the appended schematic Figures.

### BRIEF DESCRIPTION OF THE DRAWINGS

FIG. 1 is a longitudinal cross-sectional view of a geared motor.

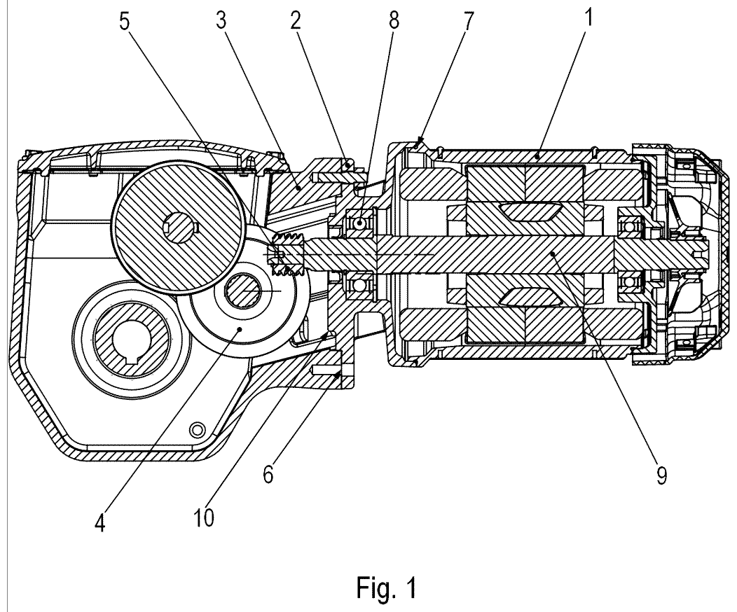

FIG. 2 is a perspective view of a bearing flange 2 of the motor.

FIG. 3 is a perspective view of the bearing flange 2 from a different angle.

FIG. 4 is a side view of the bearing flange 2.

FIG. 5 is a cross-sectional view of the bearing flange 2.

### DETAILED DESCRIPTION

As illustrated in the Figures, the converter motor has a rotor shaft which is rotatably mounted via a first bearing 8 and a further bearing.

The first bearing 8 is received in a bearing flange 2.

The bearing flange 2 has a first cheek 40 and a second cheek 41, which are connected via a web 42.

The first bearing 8 is received in the bearing flange 2, e.g., radially within the web 42, in which the axis of rotation of the first bearing 8 is oriented coaxially to the axis of rotation of the rotor shaft 9.

The first cheek 40 is connected to a stator housing 1 on its side facing the rotor shaft 9, in which a first centering collar 7 is formed on the first cheek 40 or alternatively on the stator housing 1. The first centering collar 7 is circular-cylindrical in shape, i.e., it has a circular cylinder section, e.g., a section of a hollow circular cylinder. The first centering collar 7 is oriented coaxially to the rotor shaft 9. For example, the cylinder axis and/or axis of rotational symmetry of the centering collar 7 is oriented coaxially to the axis of rotation of the rotor shaft 9, so that, for example, it coincides with it and/or is identical or equal to it.

The second cheek 41 is connected to a housing part 3 of the gearbox on its side facing away from the rotor shaft 9, and a second centering collar 10 is formed on the second cheek 41 or alternatively on the housing part 3. This second centering collar 10 is also circular-cylindrical in shape, i.e., it has a circular cylinder section, e.g., a section of a hollow circular cylinder. However, the associated cylinder axis, i.e., the axis of rotational symmetry of the second centering collar 10, is oriented parallel to the axis of rotation of the rotor shaft 9 and at a distance from this axis of rotation of the rotor shaft 9.

The bearing flange 2 is connected to the stator housing 1 via screws that are screwed into first holes, or tie rods are used to hold the housing parts of the motor together, which tie rods are passed through first holes.

For example, the axis of rotational symmetry of the pattern of holes of the first holes is oriented coaxially and concentrically to the axis of rotation of the rotor shaft 9.

The pattern of holes 6 of the second screws, which connect the bearing flange 2 to the housing part 3 of the gearbox, has an axis of rotational symmetry which is spaced apart from the axis of rotation of the rotor shaft 9 and is oriented parallel to it.

The rotor shaft 9 thus projects eccentrically and/or off-center from the bearing flange 2 into the gearbox on the gearbox side.

The rotor shaft 9 projects through a stepped through-bore, e.g., a bearing receiving bore, of the bearing flange 2, and the bearing, e.g., the outer ring of the first bearing, is received axially in front of the step and a shaft seal ring is received axially behind the step, which shaft seal ring seals towards the rotor shaft 9.

The pinion 5 has a worm gearing, e.g., ZA worm gearing, and is in mesh with the gearing of a crown-toothed gear 4. The teeth of the crown-toothed gear 4 extend in an arc from radially inwards to radially outwards, i.e., with a progressively increasing circumferential angle position with increasing radial distance from the axis of rotation of the gear 4.

There is a distance, e.g., a non-vanishing distance, between the axis of rotation of the gear 4 and the axis of rotation of the rotor shaft 9 and/or the pinion 5.

The axis of rotation of the gear 4 is oriented perpendicular to the axis of rotation of the rotor shaft 9 and/or the pinion 5.

The gearbox preferably has further gear stages. For example, a further gear wheel is connected to the gear 4 for conjoint rotation and is in mesh with a third gear wheel, which is in mesh with a fourth gear wheel.

The inner hole wall of the stepped hole is oriented concentrically to the axis of rotation of the rotor shaft.

The rotor shaft 9 projects with the pinion 5, which is connected to it for conjoint rotation, through an opening in the housing part 3 of the gearbox into the interior of the gearbox, which is at least partially filled with oil. This opening, this continuous opening formed, e.g., as a channel, especially a drawing channel, is created by drawing a slider during the casting production of the housing part 3. The drawing direction has a non-vanishing angle to the axis of rotation of the rotor shaft 9, e.g., an angle between 10° and 40°. In this angle range, the pinion 5 is sufficiently spaced apart from the material of the housing part 3, e.g., from the channel wall, even when partially projecting into the interior of the gearbox.

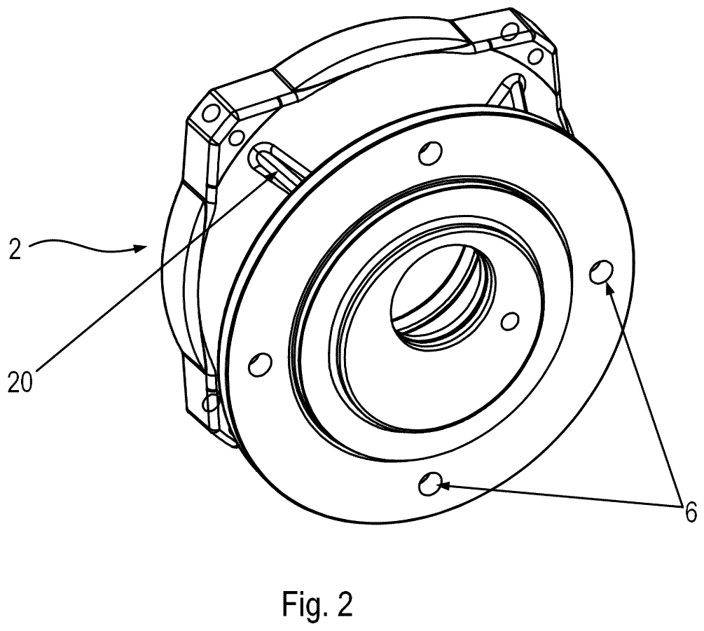

As illustrated in FIGS. 2 to 4, ribs 20 are formed radially outside the web 42 on the bearing flange, which connect the first cheek 40 with the second cheek 41. The ribs 20 project radially from the web 42 and are spaced apart from one another in the circumferential direction. The ribs 20 are formed onto the web 42 and rise in the radial direction.

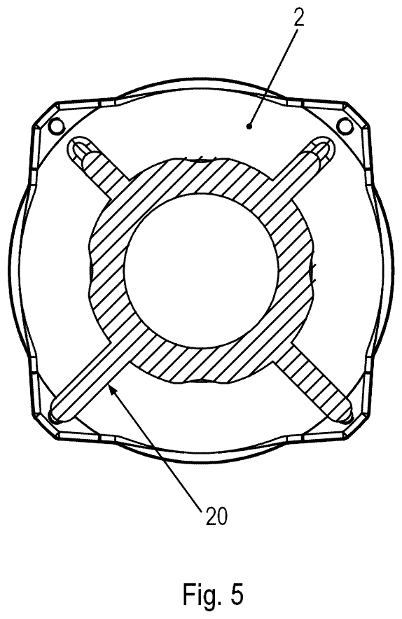

However, the ribs 20 are of different lengths in the radial direction. The maximum extension of the ribs 20, e.g., the radial extension, is thus a non-constant, e.g., variable, function of the circumferential angle. This is clearly illustrated in FIG. 5.

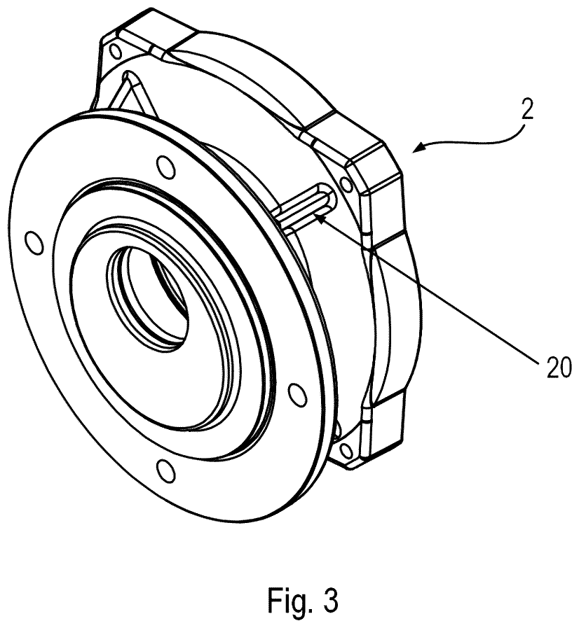

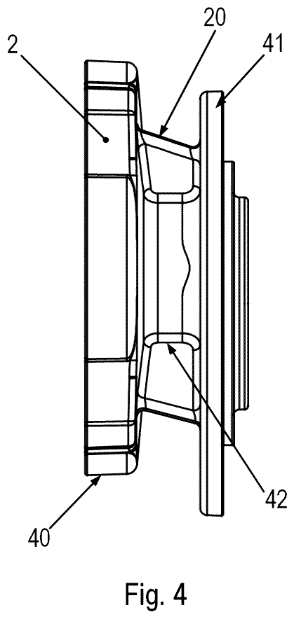

As clearly illustrated in FIGS. 3 and 4, the ribs 20 extend axially obliquely, as the motor-side pattern of holes of the bearing flange 2 is not oriented concentrically and/or coaxially to the gearbox-side pattern of holes.

Thus, the outermost radial distance of the respective rib 20 decreases monotonically, e.g., strictly monotonically, with increasing axial distance from the stator housing 1.

For example, the bearing flange is exchanged for a further bearing flange to form a further variant of a geared motor, in which further bearing flange the centering collars 7 and 10 and the patterns of holes are all oriented rotationally symmetrically, e.g., discretely rotationally symmetrically to the axis of rotation of the rotor shaft, e.g., thus also concentrically and/or coaxially.

Although there is still an axial offset, i.e., a distance, between the axis of rotation of the rotor shaft 9 and the axis of rotation of the gear 4, this is much smaller and thus also the maximum achievable transmission ratio of the gearbox.

In this manner, different variants of a type series can be produced with a small number of components. A high degree of variance can be achieved with the small number of components. For this purpose, two different bearing flanges 2 must be stored in the bearing, the first having a gearbox-side pattern of holes that is not oriented concentrically to the motor-side pattern of holes and the second having a gearbox-side pattern of holes that is oriented concentrically to the motor-side pattern of holes.

### LIST OF REFERENCE NUMERALS

1 Stator housing
2 Bearing flange
3 Housing part of the gearbox
4 Gear
5 Pinion
6 Pattern of holes for screws
7 First centering collar
8 Bearing
9 Rotor shaft
10 Second centering collar
20 Rib
40 Cheek
41 Cheek
42 Web

1-15. (canceled)

16. A geared motor, comprising:
a gearbox including a housing part;
an electric motor including a stator housing;
a bearing flange including a motor-side pattern of holes and a gearbox-side pattern of holes;
a rotor shaft; and
a bearing received in the bearing flange and including an inner ring mounted onto the rotor shaft;
wherein the motor-side pattern of holes has an axis of rotational symmetry, a discreet axis of rotational symmetry, and/or an integer axis of rotational symmetry that is parallel to and spaced apart from, and not coaxial to, an axis of rotational symmetry, a discreet axis of rotational symmetry, and/or an integer axis of rotational symmetry of the gearbox-side pattern of holes.

17. The geared motor according to claim 16, wherein the motor-side pattern of holes is on arranged on a side of the bearing flange facing away from the housing part of the gearbox and is adapted for first fastening elements and/or first screws connecting the stator housing to the bearing flange, and the gearbox-side pattern of holes face away from the stator housing and is adapted for second fastening elements and/or second screws connecting the housing part of the gearbox to the bearing flange.

18. A geared motor, comprising:
a gearbox including a housing part;
an electric motor including a stator housing;
a bearing flange including a first cheek and a second cheek connected to the first cheek via a web;
a rotor shaft; and
a bearing received in the bearing flange and including an inner ring mounted onto the rotor shaft;
wherein the first cheek is centered relative to the stator housing via a first centering collar arranged on the first cheek or on the stator housing;
wherein the second cheek is centered to the housing part of the gearbox via a second centering collar arranged on the second cheek or on the housing part of the gearbox;
wherein the first centering collar has an axis of rotational symmetry oriented parallel to and spaced apart from an axis of rotational symmetry of the second centering collar and/or the first centering collar is arranged as an uninterrupted ring and/or an interrupted circular ring having a ring axis spaced apart from a ring axis of the second centering collar arranged as an uninterrupted ring and/or an interrupted circular ring.

19. The geared motor according to claim 18, wherein the second cheek is arranged on a side of the web axially facing away from the stator housing, and the first cheek is arranged on a side axially facing away from the housing part of the gearbox, the axial direction being oriented parallel to an axis of rotation of the rotor shaft.

20. The geared motor according to claim 18, wherein the first centering collar includes a first hollow cylinder, and the second centering collar includes a second hollow cylinder.

21. The geared motor according to claim 16, wherein an axis of rotation of the rotor shaft is oriented coaxially to the discrete and/or the integer axis of rotational symmetry of the motor-side pattern of holes.

22. The geared motor according to claim 18, wherein an axis of rotation of the rotor shaft is oriented coaxially to the axis of rotational symmetry of the first centering collar and/or to the ring axis of the first centering collar.

23. The geared motor according to claim 16, wherein an axis of rotation of the rotor shaft is coaxial to an axis of rotation of the bearing, and/or a shaft seal ring is arranged in the bearing flange and seals towards the rotor shaft.

24. The geared motor according to claim 23, wherein the shaft seal ring is arranged on a side axially facing away from the stator housing, and the shaft seal ring is arranged coaxially to the bearing.

25. The geared motor according to claim 16, wherein a pinion is connected to the rotor shaft for conjoint rotation and is in mesh with a crown-toothed gear having axis of rotation oriented perpendicular to an axis of rotation of the rotor shaft, the pinion including worm gearing.

26. The geared motor according to claim 25, wherein the gear includes teeth extending in an arc from radially inwards to radially outwards in a circumferential direction.

27. The geared motor according to claim 25, wherein the gear is connected to a further gear wheel for conjoint rotation, the further gearing being in mesh with a third gear wheel that is connected to an output shaft of a transmission, or is connected to a fourth gear wheel for conjoint rotation that is connected to an output shaft of the gearbox.

28. The geared motor according to claim 16, wherein the housing part is arranged as a cast part, a channel passes through a wall of the housing part having a non-vanishing angle and/or an angle between 10° and 40° to an axis of rotation of the rotor shaft.

29. The geared motor according to claim 28, wherein the rotor shaft includes a pinion and projects into and/or through the channel.

30. The geared motor according to claim 25, wherein a axis of rotation of the gear is oriented perpendicular to and/or has a non-vanishing axial distance to an axis of rotation of the rotor shaft.

31. The geared motor according to claim 18, wherein the first centering collar is oriented parallel to the second centering collar, and/or ribs are arranged on the web of the bearing flange.

32. The geared motor according to claim 31, wherein the axis of rotational symmetry of the first centering collar is oriented parallel to the axis of rotational symmetry of the second centering collar, and/or the ribs are spaced apart and/or evenly spaced apart from one another in a circumferential direction and/or in relation to an axis of rotation of the rotor shaft.

33. The geared motor according to claim 31, wherein an outermost radial distance of each rib decreases monotonically and/or strictly monotonically with increasing axial distance from the stator housing.

34. The geared motor according to claim 31, wherein at least two of the ribs have a different extension in a radial direction and/or a extension of the ribs in a radial direction is a non-constant function of circumferential angle.

35. The geared motor according to claim 31, wherein, at a respective circumferential angle, a radial distance region covered by a respective rib in a radial direction is adjacent to a radial distance region covered by the web.

36. A method for producing variants of a type series of geared motors, comprising:
connecting a selective one of a first bearing flange, including a motor-side pattern of holes and a gearbox-side pattern of holes, or a second bearing flange, including a first cheek and a second cheek connected to the first cheek via a web, of a modular system to a housing part of the modular system and to a stator housing of the modular system to produce:
(a) a first geared motor including:
a gearbox including the housing part;
an electric motor including the stator housing;
the bearing flange;
a rotor shaft; and
a bearing received in the first bearing flange and including an inner ring mounted onto the rotor shaft;
wherein the motor-side pattern of holes has an axis of rotational symmetry, a discreet axis of rotational symmetry, and/or an integer axis of rotational symmetry that is parallel to and spaced apart from, and not coaxial to, an axis of rotational symmetry, a discreet axis of rotational symmetry, and/or an integer axis of rotational symmetry of the gearbox-side pattern of holes; or
(b) a second geared motor including:
a gearbox including the housing part;
an electric motor including the stator housing;
the second bearing flange;
a rotor shaft; and
a bearing received in the second bearing flange and including an inner ring mounted onto the rotor shaft;
wherein the first cheek is centered relative to the stator housing via a first centering collar arranged on the first cheek or on the stator housing;
wherein the second cheek is centered to the housing part of the gearbox via a second centering collar arranged on the second cheek or on the housing part of the gearbox;
wherein the first centering collar has an axis of rotational symmetry oriented parallel to and spaced apart from an axis of rotational symmetry of the second centering collar and/or the first centering collar is arranged as an uninterrupted ring and/or an interrupted circular ring having a ring axis spaced apart from a ring axis of the second centering collar arranged as an uninterrupted ring and/or an interrupted circular ring;
wherein the second geared motor has a lower transmission ratio than the first geared motor.

37. The method according to claim 36, wherein the second bearing flange has a motor-side pattern of holes and/or a motor-side pattern of holes on a side facing away from the housing part of the gearbox for first fastening elements and/or first screws connecting the stator housing to the bearing flange, the second bearing flange has a gearbox-side pattern of holes and/or a gearbox-side pattern of holes facing away from the stator housing for second fastening elements and/or second screws connecting the housing part of the gearbox to the second bearing flange, the motor-side pattern of holes of the second bearing flange having a discreet or integer axis of rotational symmetry coaxial to a discreet or integer axis of rotational symmetry of the gearbox-side pattern of holes.

38. The method according to claim 36, wherein the second cheek is arranged on a side of the web axially facing away from the stator housing, and the first cheek is arranged on a side axially facing away from the housing part of the gearbox, the axial direction being oriented parallel to an axis of rotation of the rotor shaft, the first centering collar includes a first hollow cylinder, and the second centering collar includes a second hollow cylinder.
